(19) United States
(12) Patent Application Publication
(10) Pub. No.: US 2008/0018053 A1
(43) Pub. Date: Jan. 24, 2008

(54) Encoder-equipped sealing device

(76) Inventor: Hironori Yamamoto, Okayama (JP)

Correspondence Address: WENDEROTH, LIND & PONACK, L.L.P., 2033 K STREET N. W., SUITE 800, WASHINGTON, DC, 20006-1021, US

(21) Appl. No.: 11/902,327

(22) Filed: Sep. 20, 2007

Related U.S. Application Data
(63) Continuation of application No. 11/500,402, filed on Aug. 8, 2006, now abandoned.
Application No. 11/500,402 is a continuation of application No. 10/690,550, filed on Oct. 23, 2003, now abandoned.

(30) Foreign Application Priority Data
Oct. 24, 2002 (JP) 2002-309088

(51) Int. Cl. F16J 15/00

(52) U.S. Cl. 277/317

(57) ABSTRACT

An encoder-equipped sealing device, that is, a sealing device that has an encoder incorporated therein is disclosed, which comprises a combination of seal elements, each of which includes an annular metal core having a substantially L-shaped cross section and including a cylindrical portion and a flange portion provided on one end of the cylindrical portion and extending in a direction perpendicular to a direction in which the cylindrical portion extends. One seal element, of the two seal elements, and the other seal element are combined such that a space defined by the cylindrical portion and flange portion of the one seal element, and a space defined by the cylindrical portion and flange portion of the other seal element, face opposite each other, wherein the one seal element further includes an elastic seal portion provided on the flange portion and arranged in the space defined by the cylindrical portion and flange portion, and the other seal element further includes a magnet-based encoder provided on the flange portion. The one seal element further includes a projecting portion on an end of the cylindrical portion on a side on which the flange portion is located and extending beyond a side of the flange portion opposite a side on which the seal portion is located and in a direction in which the cylindrical portion extends.

This application is a continuation of U.S. Ser. No. 11/500,402, filed Aug. 6, 2006, which is a continuation of U.S. Ser. No. 10/690,550, filed Oct. 23, 2003.

### BACKGROUND

1. Field of the Invention

The present invention relates to an improvement to and/or in an encoder-equipped sealing device or sealing device that has a magnet-based encoder incorporated therein. More particularly, the present invention relates to such encoder-equipped sealing device that provides capabilities for preventing physical cohesion by magnetic attraction from occurring between two or more units of encoder-based sealing devices that are adjacent to each other, when these units are placed one over another so that they are oriented in one particular direction.

2. Description of the Prior Art

An encoder (pulse coder) that is incorporated in the encoder-equipped sealing device that has been described above takes the form of a pulse generator ring that may be mounted on an automotive vehicle in order to flexibly control a device that ensures that the vehicle can be running with safety and stability, such as an anti-lock braking system (ABS), traction control system (TCS) and stability control system (SCS). This encoder may be mounted on a hub flange in a suspension system together with a sensor, and is used to detect a number of revolutions for each of the vehicle wheels. The encoder is mounted on each of four wheels, such as front, rear, right and left wheels, together with the sensor, and may be used to detect any difference in a number of revolutions between each of the wheels. In response to such difference, the encoder may turn a drive system or brake system on and off, thereby controlling behavior of the vehicle to ensure that the vehicle can be running with stability and safety in case some emergency situation should occur.

Lubrication oil may leak from bearing units on the automotive vehicle on which the safety running devices are installed as described above, and seals are required to avoid such leaks. Most of the sealing devices include integrated sealing and rotation detecting capabilities, and may be mounted in a gap or space that is available on the bearing units to meet such needs.

Typically, a sealing device that has been proposed for those recent years provides a rotation detecting function as well as encoder function, and has been used widely for practical purposes.

The typical encoder-equipped sealing device that has been proposed and practically used will be described below by referring to FIG. 8.

Two units 41, 42 of the encoder-equipped sealing device are shown in FIG. 8, in which each of the units includes two seal elements 3, 2 combined together.

Specifically, the seal element 3 includes a metal core 31 having a substantially L-shaped cross section, wherein the metal core 31 has a cylindrical portion 31a and a flange portion 31b extending from one end of the cylindrical portion 31a in a direction perpendicular to a direction in which the cylindrical portion 31a extends. The seal element 3 further includes an elastic seal portion 6 on the flange portion 31b that is arranged in a space defined by the cylindrical portion 31a and flange portion 31b.

Similarly to the seal element 3, the seal element 2 includes a metal core 21 having a substantially L-shaped cross section, wherein the metal core 21 has a cylindrical portion 21a and a flange portion 21b extending from one end of the cylindrical portion 21a in a direction perpendicular to a direction in which the cylindrical portion 21a extends. The seal element 2 further includes a magnet-based encoder 1 that is arranged on the flange portion 21b.

It may be seen from FIG. 8 that the seal element 3 and seal element 2 are combined such that the space defined by the cylindrical portion 31a and flange portion 31b of the seal element 3 and the space defined by the cylindrical portion 21a and flange portion 21b of the seal element 2 face opposite each other.

The encoder-equipped sealing device that includes combined seal elements 3 and 2 may be mounted on any area that needs to be sealed, such as an appropriate area in a bearing unit on an automotive vehicle, and a sensor 11 shown by dot-dash lines in FIG. 2 may be mounted adjacently to the encoder 1 so that it can face opposite the encoder 1. It may be seen from FIG. 8 that in unit 41, for example, the seal element 2 including the encoder 1 may be mounted on a rotational element, such as an inner or outer race of a bearing unit, wherein pulses that are magnetically generated by the encoder 1 may be detected by the sensor 11.

All of the encoder-equipped sealing devices that have been described above may be maintained in storage before they are actually used, such as being mounted on areas of bearing units on an automotive vehicle that need to be sealed, and each of the devices has the seal elements 2, 3 completely assembled together. In storage, these individual devices are maintained like a stack in which the devices are placed one over another such that they can be oriented in one particular direction, for convenience of easy handling by appropriate handling tools. It may be seen from FIG. 8 that two units 41, 42 of the encoder-equipped sealing device, for example, are placed one over the other in a horizontal direction such that each encoder 1 is located on the right side, and is oriented in one particular direction.

Plural units of the encoder-equipped sealing device that are placed one over the other such that they are oriented in one particular direction, as shown in FIG. 8, are loaded in a magazine, and they are transported or stored while being placed one over another such that they are oriented in one particular direction in the magazine. When they are actually used, they are removed from respective magazines, and are mounted on areas of a bearing unit that need to be sealed.

In the plural units of the encoder-equipped sealing device that are placed one over the other so that they are oriented in one particular direction as shown in FIG. 8, the encoder 1 in unit 41, for example, produces a strong magnetic force that attracts metal core 31 on the seal element 3 in the other unit 42 magnetically. This may cause cohesion by magnetic attraction to occur between the seal element 2 in unit 41 and the seal element 3 in the other unit 42.

When such cohesion occurs, the two units may attract each other magnetically within the magazine, from which it is difficult to remove the units by using any appropriate fitting device that mounts the units on an area that needs to be sealed, such as an appropriate area in a bearing unit. This may cause the fitting device to become non-operational or may affect a working efficiency of the fitting device remarkably.

In another encoder-equipped sealing device that is proposed to address the problem described above, which is disclosed in Japanese patent application as published under No. 2001-141069, a seal portion is extended to provide a projection thereon. An object of providing this projection is to keep the two units of the encoder-equipped sealing device that are located adjacent each other spaced away from each other. As this projection is formed as part of an elastic seal portion, the projection thus obtained is not sufficient to prevent cohesion by magnetic attraction that occurs between the two units.

### SUMMARY OF THE INVENTION

In order to eliminate serious disadvantages and problems associated with the prior art encoder-equipped sealing devices described above, it is an object of the present invention to provide an encoder-equipped sealing device that has a simple construction and prevents cohesion by magnetic attraction that might otherwise occur between two units of the encoder-equipped sealing device that are located adjacent each other. That is to say, the object of the present invention is to provide encoder-equipped sealing devices by which an encoder-equipped sealing device can be removed from a magazine without being caught by another encoder-equipped sealing device, and then may be mounted securely on an area that needs to be sealed, such as an appropriate area in a bearing unit, even if plural units of the encoder-equipped sealing device are placed one over another such that they are oriented in one particular direction, as shown in FIG. 8, and loaded in a magazine.

The problems mentioned above may be solved by providing an encoder-equipped sealing device in accordance with the present invention that is constructed as described below.

The encoder-equipped sealing device that is proposed by the present invention comprises two seal elements 3, 2 combined together, wherein each of the elements 3, 2 includes a metal core 31, 32 having a substantially L-shaped cross section, with each of the metal cores 31, 32 having a cylindrical portion 31a, 21a and a flange portion 31b, 21b provided on one end of the cylindrical portion 31a, 21a and extending in a direction perpendicular to a direction in which the cylindrical portion 31a, 21a extends.

One seal element 3 and the other seal element 2 are combined together such that a space defined by the cylindrical portion 31a and flange portion 31b of the one seal element 3, and the space defined by the cylindrical portion 21a and flange portion 21b of the other seal element 2, face opposite each other.

The one seal element 3 further includes an elastic seal portion 6 on the flange portion 31b that is arranged in the space defined by its cylindrical portion 31a and flange portion 31b, and the other seal element 2 further includes a magnet-based encoder 1 on the flange portion 21b.

For the above-described encoder-equipped sealing device, the present invention proposes the following seven embodiments.

In an encoder-equipped sealing device according to a first embodiment of the present invention, that is shown in FIG. 1, one seal element 3 further includes a projecting portion 4a on an end of cylindrical portion 31a on a side on which flange portion 31b is located, wherein the projecting portion 4a extends beyond a side of the flange portion 31b opposite a side on which seal portion 6 is located and in a direction in which the cylindrical portion 31a extends.

In an encoder-equipped sealing device according to a second embodiment of the present invention, that is shown in FIG. 2 and is a variation of the encoder-equipped sealing device according to the first embodiment, one seal element 3 includes an end 4b at an end of cylindrical portion 31a on which flange portion 31b is located, and wherein the end 4b forms a projecting portion by folding a base end of the flange portion 31b and the end of the cylindrical portion 31a so as to overlap each other in a direction in which the cylindrical portion 31a extends.

In an encoder-equipped sealing device according to a third embodiment of the present invention, that is shown in FIG. 3, one seal element 3 further includes a projecting portion 4c extending beyond a side of flange portion 31b opposite a side on which seal portion 6 is located and extending in a direction in which cylindrical portion 31a extends.

In an encoder-equipped sealing device according to a fourth embodiment of the present invention, that is shown in FIG. 5, an end portion 4d of cylindrical portion 31a of one seal element 3 extending toward the other seal element 2 extends in a direction in which cylindrical portion 31a extends and beyond a side of the other seal element 2 opposite a side on which the other seal element 2 faces opposite the one seal element 3.

In an encoder-equipped sealing device according to a fifth embodiment of the present invention, that is shown in FIG. 4, one seal element 3 further includes a recess 4f that is formed on a side of flange portion 31b opposite a side on which seal portion 6 is located, wherein the recess 4f extends toward the side on which the seal portion 6 is located.

In an encoder-equipped sealing device according to a sixth embodiment of the present invention, that is shown in FIG. 6, encoder 1 is arranged on a side of flange portion 21b of seal element 2 opposite a side on which the flange portion 21b faces opposite seal element 3, and wherein the flange portion 21b includes a projecting portion 4e that extends beyond a surface of the encoder 1 and in a direction in which cylindrical portion 21a extends.

In an encoder-equipped sealing device according to a seventh embodiment of the present invention, that is shown in FIG. 7, one seal element 3 includes an elastic lateral side portion 5 formed on a side of flange portion 31b opposite a side on which seal portion 6 is located, and wherein the elastic lateral side portion 5 has undulations 4g formed thereon

In any of these above-described embodiments, seal portion 6 may be formed from any elastic material such as synthetic rubber, synthetic resin and the like, and annular metal core 21, 31 may be formed from iron or stainless steel. The encoder 1 is a multi-pole magnet that may be formed like an annular magnet from a mixture composed of any elastic material, such as synthetic rubber, synthetic resin or like, and any ferromagnetic material such as ferrite, rare earth or the like, in powdery forms. The annular magnet has N polarities and S polarities magnetized alternately around its circumference. The above-described seal portion, annular metal core, and encoder are known and used in the conventional encoder-equipped sealing device comprised by incorporating an encoder and sealing elements combined together, and mounted on a bearing unit in an automotive vehicle's wheel.

The encoder-equipped sealing devices that have been described in connection with the above-described embodiments are used together with a sensor that may be disposed adjacent and opposite encoder 1 so that it can detect pulses that are generated magnetically by the encoder 1. This magnet-based encoder 1 that is located on a seal element mounted on a rotational element on an automotive vehicle is rotated as the rotational element rotates, and the pulses from the encoder 1 rotating as the before described are detected by the sensor. Thereby, a number of revolutions are detected by the sensor. It may be understood from the foregoing description that the encoder-equipped sealing device of the present invention has the encoder 1 incorporated therein.

In any of the first, second, third, fourth and sixth embodiments of the present invention, when plural units of the encoder-equipped sealing device of the present invention are placed one over another adjacent each other so that they are oriented in one particular direction, for example, when two units 51, 52 of the encoder-equipped sealing device are placed one over another adjacent each other so that they are oriented in one particular direction as shown in FIG. 1, these two adjacent units 51 and 52 can be kept spaced away from each other by the cylindrical portion or flange portion of the metal core. This can maintain a gap between the two adjacent units 51 and 52 constant, and physical cohesion by magnetic attraction that would occur between the two units 51 and 52 can thus be prevented effectively.

In the fifth embodiment, when plural units of the encoder-equipped sealing device of the present invention are placed one over another adjacent each other so that they are oriented in one particular direction, for example, when two units 51, 52 of the encoder-equipped sealing device are placed one over the other adjacent each other so that they are oriented in one particular direction as shown in FIG. 1, an area of contact between the encoder and the flange portion of the metal core can be kept as small as possible, and physical cohesion by magnetic attraction that would occur between the two units can thus be prevented effectively.

In the seventh embodiment, when plural units of the encoder-equipped sealing device of the present invention are placed one over another adjacent each other so that they are oriented in one particular direction, for example, when two units 51, 52 of the encoder-equipped sealing device are placed one over the other adjacent each other so that they are oriented in one particular direction as shown in FIG. 1, a gap between these two adjacent units can be kept constant by the elastic lateral side portion 5 having the undulations 4g formed thereon, and physical cohesion by magnetic attraction that would occur between the two units can thus be prevented effectively.

It may be understood from the above description that when plural units of the encoder-equipped sealing device of the present invention are placed one over another so that they are oriented in one particular direction as shown in FIG. 1, cohesion by magnetic attraction that might otherwise occur between adjacent units can be prevented effectively. Accordingly, even if the plural units of the encoder-equipped sealing device are loaded in a magazine, with the units being placed one over another so that they are oriented in one particular direction, each encoder-equipped sealing device can be removed from the magazine without being caught by an adjacent encoder-equipped sealing device, and can then be mounted securely onto an area that needs to be sealed, such as an appropriate area in a bearing unit.

That is to say, even if plural units of the encoder-equipped sealing device are placed one over another so that they are oriented in one particular direction, each encoder-equipped sealing device can be slid relative to an adjacent encoder-equipped sealing device without causing any problems. Also, either of these two units that are located adjacently can be moved away from the other without causing any problems, so that each of the encoder-equipped sealing devices can be handled after being detached. Thus, the encoder-equipped sealing device of the present invention can be slid smoothly out of a magazine equipped in a fitting tool, without causing any problems such as being caught or stuck. Thus, the encoder-equipped sealing device can be mounted on an area that needs to be sealed, such as an appropriate area in a bearing unit, with highest reliability.

### BRIEF DESCRIPTION OF DRAWINGS

FIG. 1 is a cross sectional view of an encoder-equipped sealing device in accordance with a first embodiment of the present invention, showing that two units of the encoder-equipped sealing device, for example, are placed adjacent each other in a horizontal direction so that they are oriented in one particular direction, although some non-critical parts are not shown;

FIG. 2 is a cross sectional view of the encoder-equipped sealing device in accordance with a second embodiment of the present invention, with some non-critical parts not being shown;

FIG. 3 is a cross sectional view of the encoder-equipped sealing device in accordance with a third embodiment of the present invention, with some non-critical parts not being shown;

FIG. 4 is a cross sectional view of the encoder-equipped sealing device in accordance with a fifth embodiment of the present invention, with some non-critical parts not being shown;

FIG. 5 is a cross sectional view of the encoder-equipped sealing device in accordance with a fourth embodiment of the present invention, with some non-critical parts not being shown;

FIG. 6 is a cross sectional view of the encoder-equipped sealing device in accordance with a sixth embodiment of the present invention, with some non-critical parts not being shown;

FIG. 7 is a side elevational view of the encoder-equipped sealing device in accordance with a seventh embodiment of the present invention, with some parts being shown in cross section; and

FIG. 8 is a cross sectional view of an encoder-equipped sealing device in accordance with the prior art, showing that two units of the encoder-equipped sealing device are placed adjacent each other in a horizontal direction so that they are oriented in one particular direction, although some non-critical parts are not shown.

### DETAILED DESCRIPTION OF THE PREFERRED EMBODIMENTS

Several preferred embodiments of the present invention are now described below by referring to the accompanying drawings.

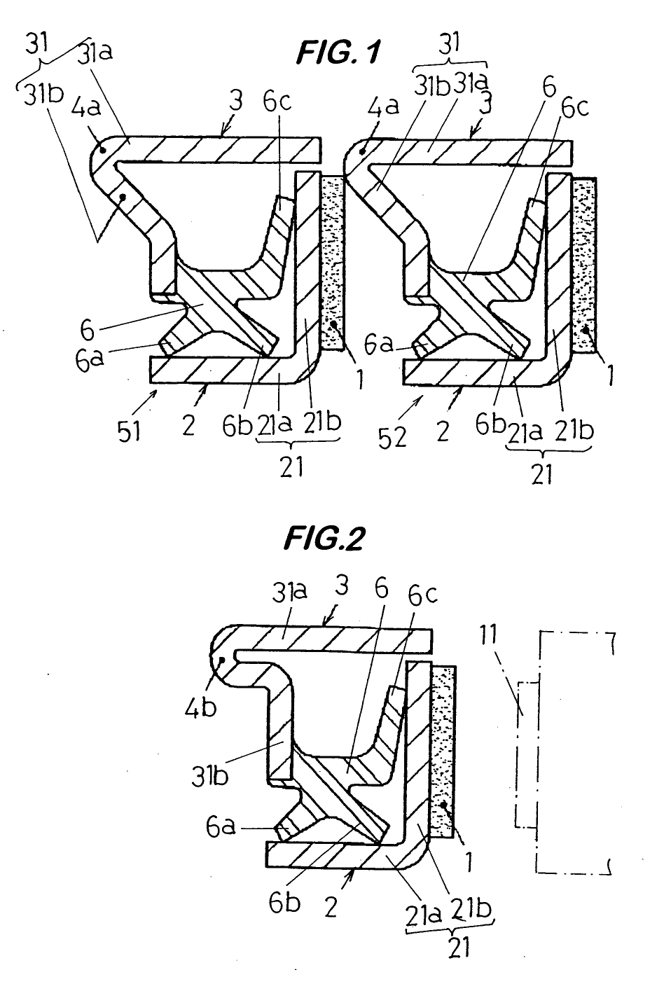

It should be noted that the encoder-equipped sealing device according to the prior art that has been described so far by referring to FIG. 8 and an encoder-equipped sealing device according to various embodiments of the present invention that will be described below by referring to FIGS. 1 through 7 contain some common parts, elements or members. In the following description, these common parts, elements or members are given same reference numerals, and are not described to avoid duplication.

Referring first to FIG. 1, an encoder-equipped sealing device according to a first embodiment of the present invention is described. In encoder-equipped sealing devices 51 and 52, seal element 3 includes a projecting portion 4a on an end of cylindrical portion 31a on a side on which flange portion 31b is located. The projecting portion 4a extends beyond a side of the flange portion 31b opposite a side on which seal portion 6 is located and in a direction in which the cylindrical portion 31a extends. That is to say, the projecting portion 4a extends beyond the left side of the flange portion 31b in FIG. 1.

In the embodiment shown in FIG. 1, an end of the cylindrical portion 31a that is located on the left side and a base end of the flange portion 31b are formed in such a manner as to extend toward the left side. This before described portion extends toward the left side in FIG. 1 and forms the projecting portion 4a.

Referring next to FIG. 2, an encoder-equipped sealing device according to a second embodiment of the present invention is described. This second embodiment is based on an inventive concept on which the first embodiment is based.

In the encoder-equipped sealing device shown in FIG. 2, seal element 3 includes an end 4b at an end of cylindrical portion 31a on which flange portion 31b is located. The end 4b forms a projecting portion as shown in FIG. 2. The end 4b is formed by folding a base end of the flange portion 31b and the end of the cylindrical portion 31a, thereby overlapping each other in a direction in which the cylindrical portion 31a extends as shown in FIG. 2.

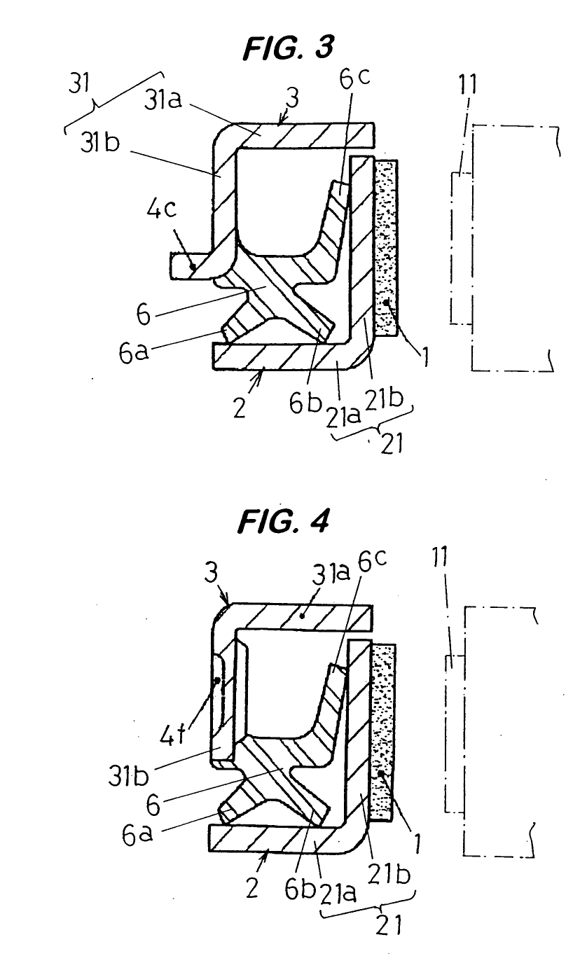

Referring next to FIG. 3, an encoder-equipped sealing device according to a third embodiment of the present invention is described.

In the encoder-equipped sealing device shown in FIG. 3, seal element 3 includes a projecting portion 4c extending beyond a side of flange portion 31b opposite a side on which seal portion 6 is located and extending in a direction in which cylindrical portion 31a extends. That is to say, the projecting portion 4c extends beyond the left side of the flange portion 31b in FIG. 3.

In the third embodiment shown in FIG. 3, the projecting portion 4c is formed by bending an end of the flange portion 31b toward the left side in FIG. 3. It should be noted that this embodiment may be varied such that the projecting portion 4c can be located on a middle portion of the flange portion 31b.

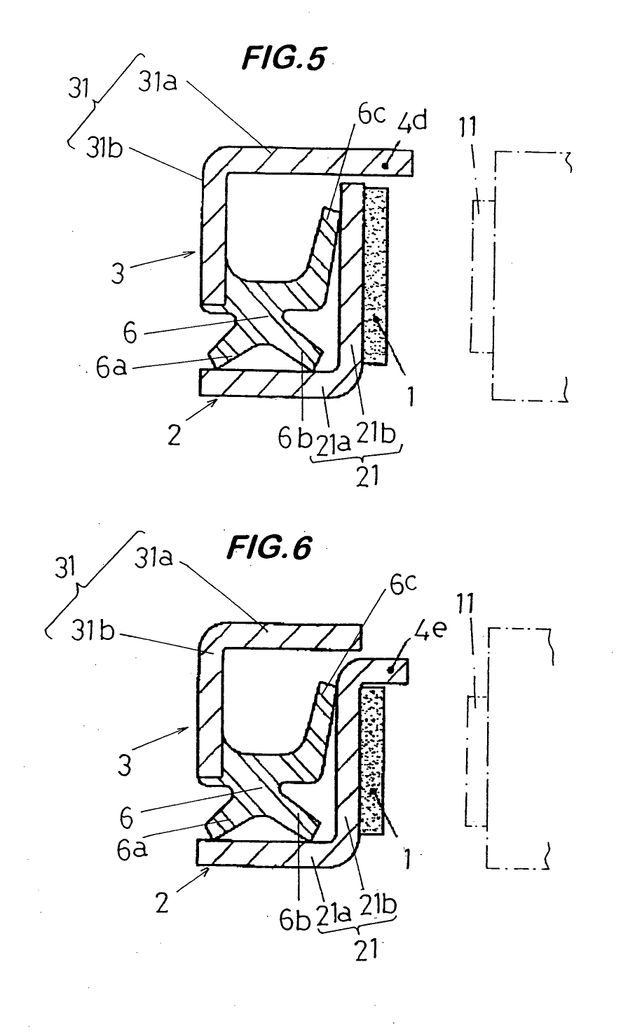

Referring next to FIG. 5, an encoder-equipped sealing device according to a fourth embodiment of the present invention is described.

In the encoder-equipped sealing device shown in FIG. 5, end portion 4d of cylindrical portion 31a of the seal element 3 extending toward another seal element 2 extends in a direction in which the cylindrical portion 31a extends. And, the end portion 4d further extends beyond a side of the other seal element 2 opposite the side on which the other seal element 2 faces opposite the seal element 3. That is to say, the end portion 4d of the cylindrical portion 31a of the seal element 3 extends beyond the right side of the seal element 2 in the direction in which the cylindrical portion 31a extends.

In the fourth embodiment shown in FIG. 5, an encoder 1 is arranged on a side (right side in FIG. 5) of flange portion 21b opposite a side on which the flange portion 21b faces the seal element 3. Since the end portion 4d of the cylindrical portion 31a of the seal element 3 extends beyond the side (right side in FIG. 5) of the seal element 2 opposite the side on which the seal element 2 faces the seal element 3, the end portion 4d extends beyond the right side of the encoder 1 in FIG. 5 and in the direction in which the cylindrical portion 31a extends.

Referring next to FIG. 6, an encoder-equipped sealing device according to a sixth embodiment of the present invention is described.

In the encoder-equipped sealing device shown in FIG. 6, encoder 1 is arranged on a side of flange portion 21b of seal element 2 opposite a side on which the flange portion 21b faces opposite seal element 3. That is to say, the encoder 1 is disposed on the right side of the flange portion 21b of the seal element 2. And, the flange portion 21b includes a projecting portion 4e that extends beyond a surface of the encoder 1 and in a direction in which cylindrical portion 21a extends.

In the sixth embodiment shown in FIG. 6, the projecting portion 4e is formed by bending the end of the flange portion 21b, and the projecting portion 4e extends beyond the right side of the encoder 1 and in the direction in which the cylindrical portion 21a extends.

In any of the embodiments described above by referring to FIGS. 1, 2, 3, 5 and 6, when two units of the encoder-equipped sealing device as designated by 51, 52 are placed one over the other adjacently to each other in a particular direction as shown in FIG. 1 so that these units are oriented in one particular direction, projecting portion 4a, end portion 4b forming projecting portion, the projecting portion 4c, the end 4d and the projecting portion 4e can exist between the two adjacent units 51 and 52.

These projecting portions and ends that exist between the two adjacent units 51 and 52 can prevent the encoder 1 in one unit and the flange portion 31b in the other unit from contacting each other over a wide area, as opposed to the case shown in FIG. 8.

Thus, a magnetic force produced from the encoder 1 in unit 51 against the flange portion 31b in unit 52 can be reduced greatly.

This can prevent cohesion by magnetic attraction from occurring between two adjacent units 51 and 52.

In particular, in each of the embodiments shown in FIGS. 5 and 6, the end portion 4d or projecting portion 4e in one unit can abut the flange portion 31b in the other adjacent unit, which can prevent the encoder 1 in unit 51 from contacting the flange portion 31b in unit 52. Thus, those embodiments are very advantageous in that cohesion by magnetic attraction between the two adjacent units 51 and 52 can be prevented.

It should be noted that in each of the embodiments shown in FIGS. 1, 2 and 3, an area of contact between the encoder 1 in unit 51 and the flange portion 31b in unit 52 can be made as small as possible by modifying a size of the flange portions 21b, 31b as viewed vertically in respective figures, a size of the encoder 1, a size of the projecting portion 4a, and a size of end 4b forming a projecting portion, respectively.

In each of the embodiments shown in FIGS. 5 and 6, respective end portion 4d and projecting portion 4e may be extended further toward the right side in FIGS. 5 and 6, respectively. In this way, a gap between the encoder 1 and sensor 11, located adjacently to and opposite the encoder 1, can be covered like an umbrella by the end portion 4d and projecting portion 4e. Thus, the gap between the encoder 1 and sensor 11 can be protected from any foreign matter that might otherwise enter the gap.

In each of the embodiments described so far by referring to FIGS. 1, 2, 3, 5 and 6, a gap between the units 51 and 52 that are located adjacently to each other is determined by presence of the projecting portion 4a, the end portion 4b forming the projecting portion, the projecting portion 4c, the end portion 4d, and the projecting portion 4e. Thus, these projecting portions 4a-4e, which are made of metal, can maintain the gap between the adjacent units 51 and 52 constant as it is originally designed.

Referring to FIG. 4, the encoder-equipped sealing device according to a fifth embodiment of the present invention is now described.

In the encoder-equipped sealing device shown in FIG. 4, seal element 3 includes a recess 4f that is formed in a side of flange portion 31b opposite a side on which seal portion 6 is located. The recess 4f extends toward a side on which the seal portion 6 is located. That is to say, the recess 4f is formed at the left side of flange portion 31b in FIG. 4, and the recess 4f extends toward the right side in FIG. 4.

When two units 51, 52 of the encoder-equipped sealing device are placed one over the other adjacently to each other so that they are oriented in one particular direction, as shown in FIG. 1, presence of the recess 4f can maintain an area of contact between the encoder 1 in one unit 51 and the flange portion 31b in the other unit 52 as small as possible. This can reduce a magnetic force attracting two units 51 and 52, and can thus prevent the two units from attracting each other magnetically. This recess 4f may be formed by using a knurling process, for example.

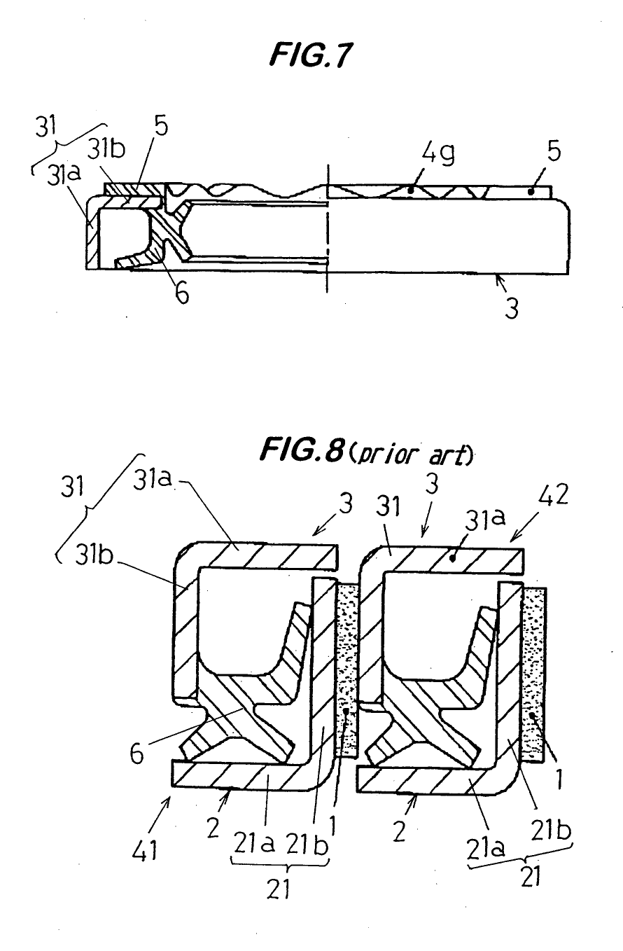

Referring next to FIG. 7, an encoder-equipped sealing device according to a seventh embodiment of the present invention is described.

In the encoder-equipped sealing device shown in FIG. 7, seal element 3 includes an elastic lateral side portion 5 formed on a side of flange portion 31b opposite a side on which seal portion 6 is located. The elastic lateral side portion 5 has undulations 4g formed thereon. This elastic lateral side portion 5 may be made of any elastic material, such as synthetic rubber, synthetic resin and the like.

When two units 51, 52 of the encoder-equipped sealing device are placed one over the other adjacently to each other so that they are oriented in one particular direction, as shown in FIG. 1, the elastic lateral side portion 5 having the undulations 4g thereon can maintain a gap between the two units 51 and 52 constant, thereby preventing cohesion by magnetic attraction that might occur between the two units 51 and 52.

In the embodiment shown in FIG. 7, it should be noted that the elastic lateral side portion 5 having the undulations 4g thereon exists between the encoder 1 in one unit 51 and metal flange portion 31b in the other unit 52 that is located adjacently to unit 51. The elastic lateral side portion 5 can maintain the encoder 1 in the one unit 51 in soft contact with the metal flange portion 31b in the other unit 52, which will prevent the encoder 1 from being deformed or having high molecular cohesion with the metal flange portion 31b.

In each of the embodiments shown in FIGS. 1 through 7, it should be noted that the seal portion 6 includes radial lips 6a, 6b extending from a side, at which cylindrical portion 31a exists, toward a forward end of the flange portion 31b and in a direction in which the cylindrical portion 31a extends, so as to extend obliquely, and a side lip 6c extending from a forward end of the flange portion 31b toward the cylindrical portion 31a and in a direction in which the cylindrical portion 31a extends, so as to extend obliquely.

It should also be noted that when seal element 3 and seal element 2 are combined such that a space defined by the cylindrical portion 31a and flange portion 31b of the seal element 3, and a space defined by the cylindrical portion 21a and flange portion 21b of the seal element 2, can face opposite each other, the radial lips 6a, 6b can abut a circumferential surface of the cylindrical portion 21a, and the side lip 6c can abut an inner surface of the flange portion 21b.

The seal portion 6 may be made of any elastic material such as synthetic rubber, synthetic resin and the like, as it is known to the art. It should be understood that the present invention is not limited to the embodiments of the seal portion 6 described above by referring to FIGS. 1 through 7.

The encoder-equipped sealing device of the present invention is used by mounting it on a bearing unit of an automotive vehicle, which comprises an inner race and outer race rotating relative to each other, for example.

In each of the embodiments described so far by referring to FIGS. 1 through 7, it is assumed that the seal element 2 in the encoder-equipped sealing device 51 is mounted on a rotational element on an automotive vehicle. For example, the encoder-equipped sealing device according to each of these embodiments has been described, assuming that the encoder-equipped sealing device is mounted on the bearing unit while mounting the seal element 2 in the encoder-equipped sealing device 51 on the rotational element, such as an inner race. It should be understood, however, the encoder-equipped sealing device according to each of the embodiments described and shown can be mounted on a bearing unit, comprising an inner race and outer race rotating relative to each other, while mounting the seal element 2 in the encoder-equipped sealing device 51 on the outer race, which is a rotational element, although this is not shown.

Although the present invention has been described with reference to several particular preferred embodiments thereof by referring to the accompanying drawings, it should be understood that the present invention is not limited to these embodiments, and various changes and modifications may be made without departing from the spirit and scope of the invention as defined in the appended claims.

1. An encoder-equipped sealing device comprising:
a first seal element having a first substantially L-shaped cross section defined by a first cylindrical portion and a first flange portion extending substantially perpendicularly from one end of said first cylindrical portion, with said first cylindrical portion and said first flange portion defining a first space therebetween;
a second seal element having a second substantially L-shaped cross section defined by a second cylindrical portion and a second flange portion extending substantially perpendicularly from one end of said second cylindrical portion, with said second cylindrical portion and said second flange portion defining a second space therebetween;
an elastic seal portion on said first flange portion and in said first space;
a magnet-based encoder on said second flange portion; and
a non-flat projecting portion on said first seal element, said non-flat projecting portion being on a side of said first flange portion opposite to a side of said first flange portion on which said elastic seal element is located, and extending beyond said first flange portion in a direction in which said first cylindrical portion extends,
wherein said first space and said second space face one another.

2. The encoder-equipped sealing device according to claim 1, wherein
said first seal element comprises a metallic first seal element, and
said second seal element comprises a metallic second seal element.

3. The encoder-equipped sealing device according to claim 2, wherein
said non-flat projecting portion is at an end of said first cylindrical portion.

4. The encoder-equipped sealing device according to claim 3, wherein
said non-flat projecting portion is defined by a folded base end of said first flange portion and a folded end of said first cylindrical portion, with said folded base end of said first flange portion and said folded end of said first cylindrical portion overlapping one another.

5. The encoder-equipped sealing device according to claim 1, wherein
said non-flat projecting portion is at an end of said first cylindrical portion.

6. The encoder-equipped sealing device according to claim 5, wherein
said non-flat projecting portion is defined by a folded base end of said first flange portion and a folded end of said first cylindrical portion, with said folded base end of said first flange portion and said folded end of said first cylindrical portion overlapping one another.

7. The encoder-equipped sealing device according to claim 1, wherein
said non-flat projecting portion is defined by a folded base end of said first flange portion and a folded end of said first cylindrical portion, with said folded base end of said first flange portion and said folded end of said first cylindrical portion overlapping one another.

8. An encoder-equipped sealing device comprising:
a first seal element having a first substantially L-shaped cross section defined by a first cylindrical portion and a first flange portion extending substantially perpendicularly from one end of said first cylindrical portion, with said first cylindrical portion and said first flange portion defining a first space therebetween;
a second seal element having a second substantially L-shaped cross section defined by a second cylindrical portion and a second flange portion extending substantially perpendicularly from one end of said second cylindrical portion, with said second cylindrical portion and said second flange portion defining a second space therebetween;
an elastic seal portion on said first flange portion and in said first space;
a magnet-based encoder on said second flange portion; and
a non-flat projecting portion on said first seal element, said non-flat projecting portion being on a side of said first flange portion opposite to a side of said first flange portion on which said elastic seal element is located, and extending beyond said first flange portion in a direction in which said first cylindrical portion extends,
wherein said first space and said second space face one another, and
wherein said elastic seal portion and said non-flat projecting portion are not positioned at the same level in a direction away from said first cylindrical portion.

9. The encoder-equipped sealing device according to claim 8, wherein
said first seal element comprises a metallic first seal element, and
said second seal element comprises a metallic second seal element.

10. The encoder-equipped sealing device according to claim 9, wherein
said non-flat projecting portion is at an end of said first cylindrical portion.

11. The encoder-equipped sealing device according to claim 10, wherein
said non-flat projecting portion is defined by a folded base end of said first flange portion and a folded end of said first cylindrical portion, with said folded base end of said first flange portion and said folded end of said first cylindrical portion overlapping one another.

12. The encoder-equipped sealing device according to claim 8, wherein
said non-flat projecting portion is at an end of said first cylindrical portion.

13. The encoder-equipped sealing device according to claim 12, wherein
said non-flat projecting portion is defined by a folded base end of said first flange portion and a folded end of said first cylindrical portion, with said folded base end of said first flange portion and said folded end of said first cylindrical portion overlapping one another.

14. The encoder-equipped sealing device according to claim 13, wherein
said non-flat projecting portion is defined by a folded base end of said first flange portion and a folded end of said first cylindrical portion, with said folded base end of said first flange portion and said folded end of said first cylindrical portion overlapping one another.

15. An encoder-equipped sealing device comprising:
a first seal element having a first substantially L-shaped cross section defined by a first cylindrical portion and a first flange portion extending substantially perpendicularly from one end of said first cylindrical portion, with said first cylindrical portion and said first flange portion defining a first space therebetween;
a second seal element having a second substantially L-shaped cross section defined by a second cylindrical portion and a second flange portion extending substantially perpendicularly from one end of said second cylindrical portion, with said second cylindrical portion and said second flange portion defining a second space therebetween;
an elastic seal portion on said first flange portion and in said first space;
a magnet-based encoder on said second flange portion; and
a projecting portion on said first seal element, said projecting portion being on a side of said first flange portion opposite to a side of said first flange portion on which said elastic seal element is located, and extending beyond said first flange portion in a direction in which said first cylindrical portion extends,
wherein said first space and said second space face one another, and
wherein said elastic seal portion and said projecting portion are not positioned at the same level in a direction away from said first cylindrical portion.

16. The encoder-equipped sealing device according to claim 15, wherein
said first seal element comprises a metallic first seal element, and
said second seal element comprises a metallic second seal element.

17. The encoder-equipped sealing device according to claim 16, wherein
said projecting portion is at an end of said first cylindrical portion.

18. The encoder-equipped sealing device according to claim 17, wherein
said projecting portion is defined by a folded base end of said first flange portion and a folded end of said first cylindrical portion, with said folded base end of said first flange portion and said folded end of said first cylindrical portion overlapping one another.

19. The encoder-equipped sealing device according to claim 15, wherein
said projecting portion is at an end of said first cylindrical portion.

20. The encoder-equipped sealing device according to claim 19, wherein
said projecting portion is defined by a folded base end of said first flange portion and a folded end of said first cylindrical portion, with said folded base end of said first flange portion and said folded end of said first cylindrical portion overlapping one another.

21. The encoder-equipped sealing device according to claim 15, wherein
said projecting portion is defined by a folded base end of said first flange portion and a folded end of said first cylindrical portion, with said folded base end of said first flange portion and said folded end of said first cylindrical portion overlapping one another.
